(19) United States
(12) Patent Application Publication
(10) Pub. No.: US 2025/0256507 A1
(43) Pub. Date: Aug. 14, 2025

(54) LIQUID EJECTION HEAD

(71) Applicant: CANON KABUSHIKI KAISHA, Tokyo (JP)

(72) Inventors: AYAKO MARUYAMA, Kanagawa (JP); TOMOHIRO SATO, Tokyo (JP); YOSHIYUKI NAKAGAWA, Kanagawa (JP)

(21) Appl. No.: 19/052,416

(22) Filed: Feb. 13, 2025

(30) Foreign Application Priority Data
Feb. 14, 2024 (JP) 2024-019938

(51) Int. Cl. B41J 2/14

(52) U.S. Cl. CPC B41J 2/14145; B41J 2/1433

(57) ABSTRACT

A liquid ejection head according to the present disclosure is a liquid ejection head including a liquid ejection substrate having: a nozzle substrate having multiple nozzles that eject a liquid; a channel substrate having multiple pressure chambers respectively communicating with the multiple nozzles, multiple individual channels respectively communicating with the multiple pressure chambers, multiple pressure generation units that respectively generate a pressure in the multiple pressure chambers, and a common channel communicating with the multiple individual channels; and a damper substrate having a damper film disposed so as to face a surface of the damper substrate facing an opening plane of a channel communicating with the common channel, and a damper chamber one side of which is covered by the damper film. The liquid ejection substrate includes an atmospheric communication port through which an inside of the damper chamber communicates with atmosphere.

### BACKGROUND OF THE INVENTION

### Field of the Invention

The present disclosure relates to a liquid ejection head and specifically to a liquid ejection head having a damper structure.

### Description of the Related Art

This type of damper structure includes a damper film which undergoes elastic deformation and a damper chamber in which air is present. This structure absorbs the pressure fluctuation occurring in a common liquid chamber due to ejection of a liquid, such as an ink, to thereby reduce the impact of the crosstalk between nozzles originating from the liquid ejection and the pressure fluctuation caused by an abrupt change in the print pattern. Japanese Patent Laid-Open No. 2019-155909 (hereinafter Literature 1) discloses a liquid ejection head in which a damper structure is disposed before pressure chambers in which a pressure for ejecting a liquid is applied, layers of channel members for supplying the liquid to the pressure chambers, and the like. This makes it possible to properly absorb the pressure fluctuation occurring in channels in the channel member due to liquid ejection.

Here, in the configuration of Literature 1, the air inside damper chambers is not in communication with the outside. Hence, in a case where, for example, the ambient temperature around the head changes, the pressure difference between the inside and outside of the damper chambers changes accordingly, which affects the behavior of the damper film when it deforms. Also, in a case where the atmospheric pressure around the head changes, the pressure on the outside of the damper chambers changes, so that the pressure difference between the inside and outside of the damper chambers likewise changes. This may result in a failure to achieve desired damper performance.

### SUMMARY OF THE INVENTION

A liquid ejection head includes a liquid ejection substrate having: a nozzle substrate having a plurality of nozzles that eject a liquid; a channel substrate having a plurality of pressure chambers respectively communicating with the plurality of nozzles, a plurality of individual channels respectively communicating with the plurality of pressure chambers, a plurality of pressure generation units that respectively generate a pressure in the plurality of pressure chambers, and a common channel communicating with the plurality of individual channels; and a damper substrate having a damper film disposed so as to face a surface of the damper substrate facing an opening plane of a channel communicating with the common channel, and a damper chamber one side of which is covered by the damper film. The liquid ejection substrate includes an atmospheric communication port through which an inside of the damper chamber communicates with atmosphere.

Further features of the present disclosure will become apparent from the following description of exemplary embodiments with reference to the attached drawings.

### BRIEF DESCRIPTION OF THE DRAWINGS

FIG. 1 is a schematic perspective view of a liquid ejection apparatus;

FIG. 2 is a perspective view of a liquid ejection head module;

FIGS. 3A to 3C are schematic views of a liquid ejection substrate;

FIGS. 4A to 4D are a plan view and cross-sectional views of a liquid ejection substrate of a liquid ejection head according to a first embodiment of the present disclosure;

FIG. 5 is a cross-sectional view of a liquid ejection head of a liquid ejection substrate according to Modification 1 of the first embodiment of the present disclosure;

FIG. 6 is a cross-sectional view of a liquid ejection head of a liquid ejection substrate according to Modification 2 of the first embodiment of the present disclosure;

FIGS. 7A to 7C are a plan view and cross-sectional views of a liquid ejection substrate of a liquid ejection head according to a second embodiment of the present disclosure;

FIGS. 8A to 8C are a plan view and cross-sectional views of a liquid ejection substrate of a liquid ejection head according to a third embodiment of the present disclosure;

FIG. 9 is a cross-sectional view of a liquid ejection head of a liquid ejection substrate according to Modification 1 of the third embodiment of the present disclosure;

FIG. 10 is a cross-sectional view of a liquid ejection head of a liquid ejection substrate according to Modification 2 of the third embodiment of the present disclosure;

FIGS. 11A to 11C are a plan view and cross-sectional views of a liquid ejection substrate of a liquid ejection head according to a fourth embodiment of the present disclosure;

FIG. 12 is a plan view of a liquid ejection substrate of a liquid ejection head according to a fifth embodiment of the present disclosure;

FIG. 13 is a plan view of a liquid ejection substrate of a liquid ejection head according to a sixth embodiment of the present disclosure;

FIGS. 14A to 14D are plan views and a cross-sectional view of a liquid ejection substrate of a liquid ejection head according to a seventh embodiment of the present disclosure;

FIGS. 15A and 15B are a plan view and a cross-sectional view of a liquid ejection substrate of a liquid ejection head according to an eighth embodiment of the present disclosure; and

FIG. 16 is a plan view of a liquid ejection substrate of a liquid ejection head according to a ninth embodiment of the present disclosure.

### DESCRIPTION OF THE EMBODIMENTS

Hereinbelow, example embodiments of the present disclosure will be described using the drawings. It is to be noted that the following description is not intended to limit the present disclosure. In the following embodiments, a thermal method in which liquids are ejected by generating bubbles with heat generation elements is employed as an example. The present disclosure is applicable also to liquid ejection heads employing a piezoelectric method and various other liquid ejection methods.

Liquid ejection heads and liquid ejection apparatuses according to embodiments of the present disclosure will now be described below with reference to the drawings. In the following embodiments, inkjet print heads and inkjet liquid ejection apparatuses that eject inks will be described based on specific configurations, but the present disclosure is not limited to these. The liquid ejection head, the liquid ejection apparatus, and the liquid supply method according to the present disclosure are applicable to apparatuses such as printers, copying machines, facsimiles with a communication system, and word processors with a printer unit, and further to industrial printing apparatuses integrally combined with various processing apparatuses. For example, the liquid ejection head, the liquid ejection apparatus, and the liquid supply method according to the present disclosure are usable in applications such as fabrication of biochips and printing of electronic circuits.

Also, the embodiments to be described below are appropriate specific examples of the present disclosure and therefore involve various technically preferable limitations. However, the embodiments are not limited to the embodiments in this specification or other specific methods as long as they are consistent with the concept of the present disclosure.

### First Embodiment

### Description of Liquid Ejection Apparatus

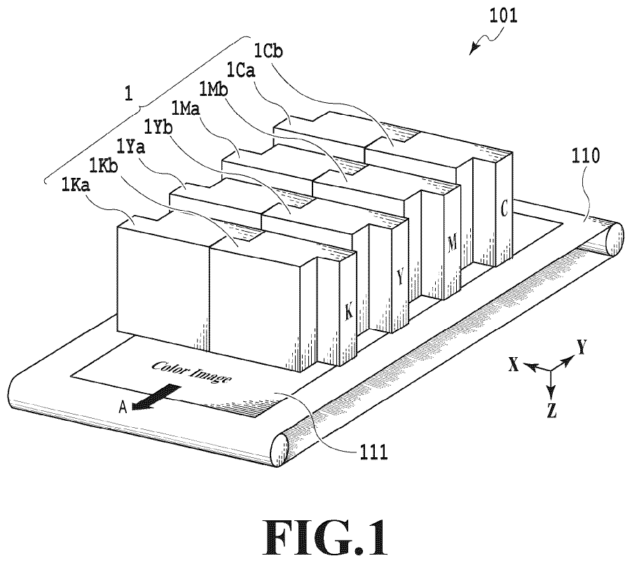

FIG. 1 is a schematic perspective view explaining a schematic configuration of a liquid ejection apparatus 101 according to an embodiment of a liquid ejection apparatus to which the present disclosure is applicable.

The liquid ejection apparatus 101 according to the present embodiment is of a one-pass type that prints an image on a print medium 111 in a single pass of the print medium, and has nozzles arrayed so as to cover the entire width of the print medium 111. The liquid ejection apparatus 101 includes a liquid ejection head module 1 of the present disclosure in a detachable manner, for example.

The print medium 111 is conveyed in the direction of the arrow A by a conveyance unit 110, and printing is performed thereon by the liquid ejection head module 1. Meanwhile, in order to perform color printing, a liquid ejection head module 1 with eight print heads 1Ca, 1Cb, 1Ma, 1Mb, 1Ya, 1Yb, 1Ka, and 1Kb that eject cyan (C), magenta (M), yellow (Y), and black (K) inks, which are liquids, is used. It is to be noted that the liquid ejection heads for these colors will be referred to collectively as “the liquid ejection head 1” in a case where they do not need to be distinguished. The liquid ejection head module according to the present disclosure can be implemented in any forms including the example of FIG. 1, and other forms are not limited either.

### Description of Configuration of Liquid Ejection Heads

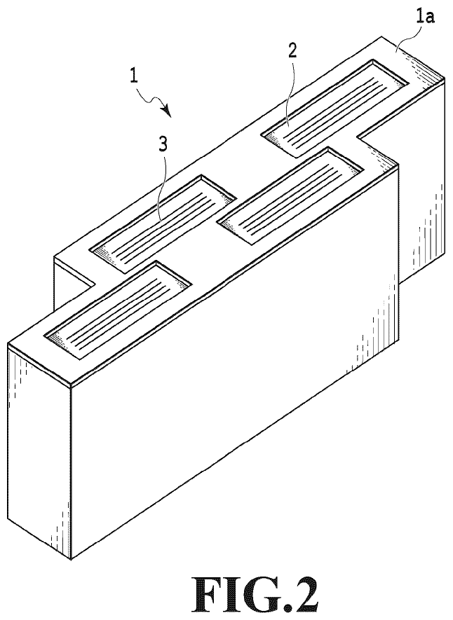

FIG. 2 is a perspective view of various types of liquid ejection head modules to which the present disclosure is applicable. The liquid ejection head 1 has a liquid ejection head main body la and multiple liquid ejection substrates 2 with nozzles 3 disposed in the liquid ejection head main body la. The ink to be ejected is supplied to the liquid ejection substrates 2 from an ink tank (not illustrated) through a common supply port (not illustrated) in the liquid ejection head main body la.

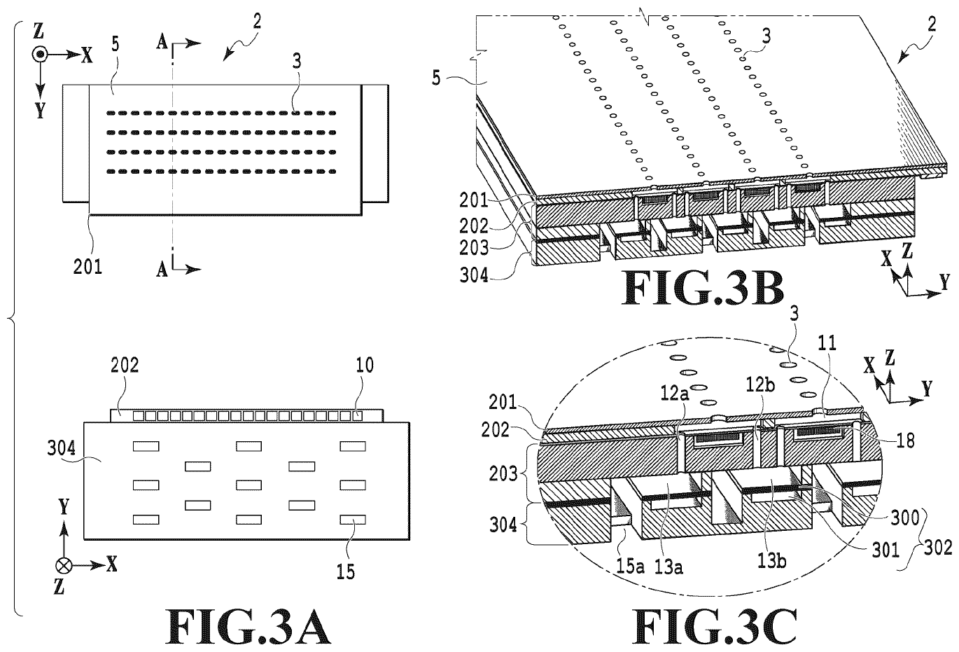

FIG. 3A is a view of a liquid ejection substrate of the liquid ejection head module according to the present disclosure as seen from its nozzle side and also a view of the liquid ejection substrate as seen from the opposite side from the nozzle side. FIG. 3B is a schematic cross-sectional view taken along the A-A line in FIG. 3A. FIG. 3C is an enlarged view of a part of FIG. 3B. Each liquid ejection substrate 2 includes four substrates consisting of a nozzle substrate 201, an actuator substrate 202, a channel substrate 203, and a damper substrate 304. The nozzles 3 are formed in the nozzle substrate 201. Multiple nozzles 3 are disposed along the X direction of the substrate to form a nozzle array. Further, multiple nozzle arrays are formed in the Y direction. The actuator substrate 202 has pressure chambers 11, diaphragms 17, and pressure generation elements 18. The channel substrate 203 has grooves that will be individual channels 12, common channels 13, and voids 19 that will surround the pressure generation elements 18. In a case where the pressure generation elements 18 are piezoelectric elements, the voids 19 are needed in order that the deformation of the piezoelectric elements that occurs in response to application of a voltage thereto will be efficiently transmitted to the diaphragms 17. The damper substrate 304 has a damper film 300, damper chambers 301, and common openings 15. The ink is supplied into the nozzle substrate 201 from the common openings 15 formed in the damper substrate 304 through the channel substrate 203. The ink is ejected from the nozzles 3 and applied onto the print medium 111. In the liquid ejection head main body la, there is disposed an electric substrate (not illustrated) for supplying electric power and signals necessary for electing the liquid. This electric substrate is connected to terminals 10a on each liquid ejection substrate 2 by wirings (not illustrated). The liquid ejection head according to the present disclosure can be implemented in any forms including the example of FIG. 2, and other forms are not limited either.

### Description of Nozzle Layout, Damper Layout, and Atmospheric Communication Ports

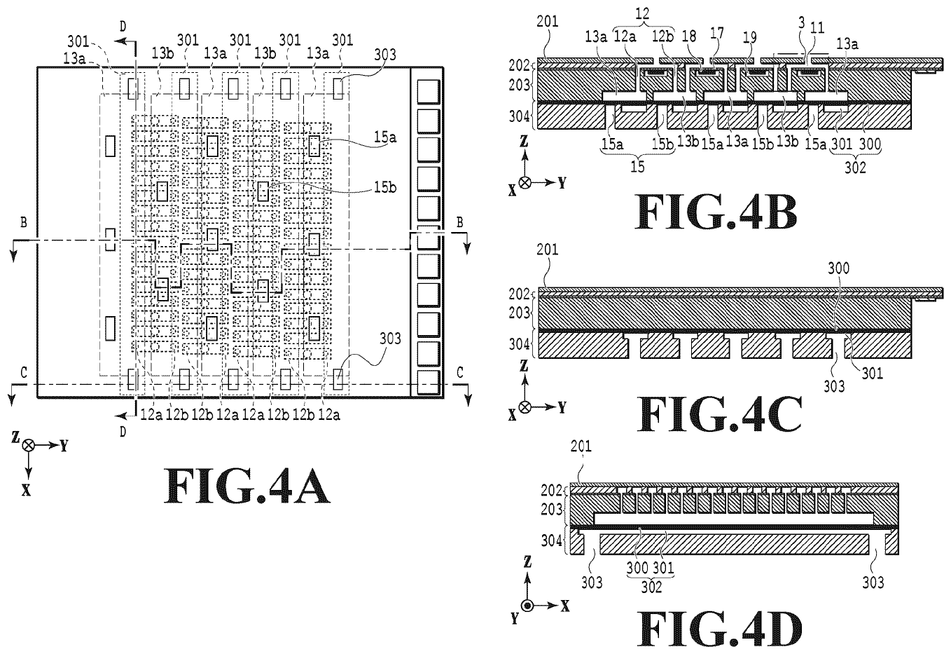

FIG. 4A is a partially enlarged transparent plan view of a liquid ejection substrate 2 of the liquid ejection head according to the present disclosure, and is a view as seen from the opposite side from the nozzles 3 side. FIG. 4B is a cross-sectional view taken along the B-B line in FIG. 4A. FIG. 4C is a cross-sectional view taken along the C-C line in FIG. 4A. FIG. 4D is a cross section taken along the D-D line in FIG. 4A. As illustrated in FIG. 4A, in the liquid ejection head 1 are formed nozzle arrays in each of which multiple units each including a nozzle 3, a pressure chamber 11, individual channels 12 communicating with the pressure chamber 11, and a pressure generation element 18 that generates a pressure in the pressure chamber 11 are arrayed in the X direction. As illustrated in FIG. 4B, the pressure generation elements 18, which are for ejecting the liquid with a pressure, are disposed at positions corresponding to the respective nozzles 3. Along each nozzle array, individual supply channels 12a forming the individual channels 12 extend on one side while individual collection channels 12b forming the individual channels 12 extend on the other side. The individual supply channels 12a and the individual collection channels 12b are channels provided in the liquid ejection substrate and extending in the Z direction, and each communicate with a nozzle 3. Also, the individual supply channels 12a and the individual collection channels 12b are each connected to a common channel 13 including a common supply channel 13a and a common collection channel 13b. The portions at which the individual supply channels 12a and the common supply channel 13a are connected and the portions at which the individual collection channels 12b and the common collection channel 13b are connected are individual openings. Damper structures 302 each including a damper chamber 301 and a damper film 300 are formed at a surface facing the surface with the individual openings. In the damper substrate 304, in which the damper structures 302 are formed, the common openings 15 are formed, which include common supply openings 15a and common collection openings 15b for the common supply channels 13a and the common collection channels 13b to connect to, respectively. The common supply channels 13a and the common collection channels 13b are formed so as to extend in the X direction, which is a direction along the nozzle arrays, and are formed in the surface on the opposite side of the pressure generation elements 18 from the ejection surface in the Z direction, in which the liquid is ejected.

Each damper chamber 301 is open to the atmosphere by having atmospheric communication ports 303 (FIGS. 4A, 4C, and 4D) at the opposite ends of the damper structure 302 in the X direction. Also, a damper structure 302 is formed for each nozzle array (FIG. 4A), thus allowing the pressure generation elements 18 to be densely disposed in each nozzle array. Further, the damper structures 302 are elongated in the X direction of the nozzle arrays to ensure damper performance. This makes it possible to shorten their lengths in the Y direction. Shortening the lengths of the damper structures 302 in the Y direction shortens the distance between the nozzle arrays adjacent to each other in the Y direction. This allows for downsizing of the liquid ejection substrate 2 and the liquid ejection head. For example, in FIGS. 4A to 4D, the pressure chambers 11 for the pressure generation elements 18 in each nozzle array have a length of 110 μm in the X direction, and the pressure chambers and the nozzles are disposed at intervals of 150 dpi. Also, by shifting the four of such nozzle arrays in the X direction, it is possible to obtain a high-density nozzle layout that achieves 600 dpi on a print medium. In the present embodiment, a 600-dpi configuration is implemented with four nozzle arrays, but the configuration is not limited to this and a 1200-dpi configuration may be implemented with eight nozzle arrays.

Next, the flow of the liquid inside a liquid ejection substrate 2 will be described. As the liquid is supplied into the common supply openings 15a, the liquid then passes through the common supply channels 13a into the individual supply channels 12a for the elements. After passing therethrough, the liquid flows through the pressure chambers 11 and the nozzles 3 and then flows through the individual collection channels 12b and the common collection channels 13b into the common collection openings 15b. In this way, the liquid supplied from the common supply openings 15a flows to and is collected at the common collection openings 15b. The liquid can be circulated by externally applying a differential pressure to the common supply openings 15a and the common collection openings 15b by means of a pump or a hydraulic head pressure. By filling the inside of each nozzle 3 with the liquid by sucking in the inside of the nozzle from an ejection surface 5 while circulating the liquid, nozzle circulation can be performed.

Increasing the density for nozzle circulation as illustrated above involves a configuration in which the pressure chambers 11 are close to one another within each nozzle array and between the nozzle arrays. Increasing the density also involves a configuration in which adjacent nozzle arrays share supply and collection channels. This leads to a concern about crosstalk in which a pressure wave in a pressure chamber 11 propagates to other pressure chambers 11 in its nozzle array and/or in the adjacent nozzle arrays, hence affecting the ejection characteristics. In the present embodiment, the damper structures 302 are disposed along the nozzle array direction, which is the X direction in the drawings. This makes it possible to densely dispose the nozzles and downsize the liquid ejection head while also absorbing crosstalk pressure waves.

The pressure generated in each pressure chamber 11 propagates through the corresponding individual supply channel 12a and individual collection channel 12b to the corresponding common supply channel 13a and common collection channel 13b. As a result, the pressure propagates to other pressure chambers 11. For this reason, the damper structures 302 are provided at positions facing the individual supply channels 12a and the individual collection channels 12b so that the pressures from the individual supply channels 12a and the individual collection channels 12b can be absorbed before propagating to the common supply channels 13a and the common collection channels 13b. Hence, in the damper substrate 304, the damper structures 302 and the common supply openings 15a and common collection openings 15b are formed so as to appear alternately. In the present embodiment, the channels and the damper structures are disposed in the order of common supply openings 15a, a damper structure 302, common collection openings 15b, a damper structure 302, . . . from the left in the Y direction on the sheet of FIG. 4A.

The liquid ejection head 1 may be used in a situation with a different ambient environment, e.g., an environment with a high atmospheric pressure, a high temperature and humidity, or the like. If the damper structures do not have the atmospheric communication ports 303 as in the present embodiment, the inside of the damper chambers of the damper structures will be tightly closed. Thus, a change in atmospheric pressure will cause a pressure difference between the common channels and the damper chambers, which may cause expansion or contraction of the gas inside the damper chambers. Also, in a case where the liquid ejection head 1 is used in a relatively hot location or in a cold location, the gas inside the damper chambers will undergo thermal expansion or contraction, thus causing a change in pressure. In a case where a pressure difference is generated between the inside and outside of the damper chambers tightly closed as above, their damper film is subjected to a corresponding biasing force in a direction toward the outside or inside of the damper chambers. Moreover, in this state of being subjected to the biasing force, the damper film is already deformed accordingly, making it difficult for the damper film to deform when absorbing the pressure at the time of ejection. In other words, the damper film's transformation characteristic (compliance characteristic) has changed. This may lead to a failure to achieve desired damper performance and thus to sufficiently absorb crosstalk pressure waves.

In contrast, according to the present embodiment, the atmospheric communication ports 303 are provided. Thus, even in a case where the temperature or pressure in the ambient environment changes, the pressure in the damper chambers 301 will be equivalent to the pressure in the ambient environment. Accordingly, the pressure difference between the inside and outside of the damper chambers 301 will be small or eliminated. This enables the damper film 300 to maintain its compliance characteristic constant and thus sufficiently absorb crosstalk pressure waves.

In the present embodiment, the atmospheric communication ports 303 are formed in the surface on the opposite side from the ejection surface 5 by the outer periphery of the liquid ejection substrate 2 at positions distant from the common openings 15, as illustrated in FIGS. 4A to 4D. This brings about the following advantages.

Members for supplying and collecting the liquid to and from the common openings 15 are disposed on the surface of the damper substrate 304 in which the atmospheric communication ports 303 are formed. Moreover, since the liquid is supplied, arranging the common openings 15 and the atmospheric communication ports 303 close to each other will lower the strength of attachment of the members, which may in turn cause leakage of the liquid. For this reason, the atmospheric communication ports 303 are provided at positions distant from the common openings 15 to ensure the strength of attachment of the members. Providing the atmospheric communication ports 303 at positions distant from the common openings 15 also allows the common openings 15 to be formed on the inner side of the liquid ejection substrate 2. This reduces the flow resistance on the liquid flowing to the pressure generation elements 18 and thus enables smooth supply and collection of the liquid. Further, the atmospheric communication ports 303 may be provided closer to the outer periphery than are the individual channels 12 at the opposite ends of each nozzle array, and the common openings 15 may be provided closer to the opposite ends of individual channels 12.

Also, the atmospheric communication ports 303 are formed at the opposite ends of each damper structure 302. In this way, the damper chamber 301 will be maintained at the atmospheric pressure even in a case where one of the atmospheric communication ports 303 is closed.

Further, the atmospheric communication ports 303 are preferably formed in the same size as the common openings 15 to facilitate the processing of the damper substrate 304. The depth (length in the Z direction) of the atmospheric communication ports 303 formed in the damper substrate 304 is preferably larger than the depth of the damper chambers 301 from the perspective of the strength of the damper substrate 304. The width (length in the Y direction) of the atmospheric communication ports 303 is preferably smaller than the width of the damper chambers 301. This can prevent entry of foreign substances such as dust into the damper chambers. In other words, the width of the atmospheric communication ports 303 in a direction that is parallel to the surfaces of the damper substrate 304 and crosses the direction of extension of the damper chambers 301 is preferably smaller than the width of the damper chambers 301.

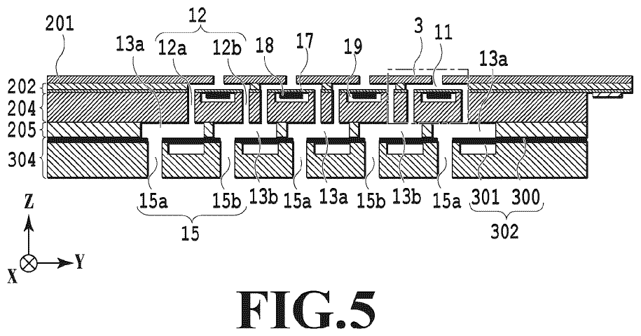

FIG. 5 is a cross-sectional view of a liquid ejection substrate representing Modification 1 of FIG. 4A.

In Modification 1 of the first embodiment, the damper substrate 304 has the damper film 300, the damper chambers 301, and the common openings 15, as illustrated in FIG. 5. Specifically, in the first embodiment, four substrates are individually processed and laminated to form the liquid ejection substrate 2. In the modification, however, the configuration may be such that the channel substrate 203 is divided into two substrates 204 and 205 in order to adjust the thickness of the common channels 13 in the Z direction, and the five substrates are laminated. Dividing the channel substrate 203 into the substrates 204 and 205 enhances the processability. In this case, the substrate 204 is an individual channel substrate in which to form the individual channels 12 while the substrate 205 is a common channel substrate in which to form the common channels 13.

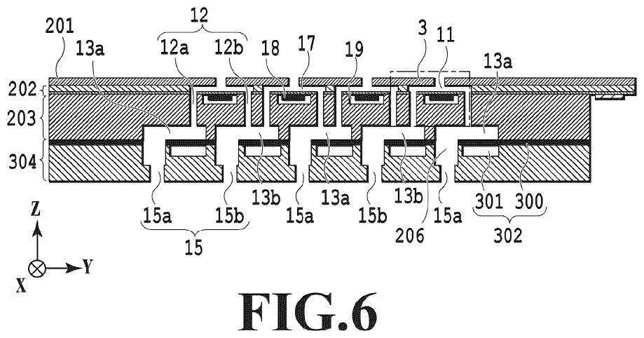

FIG. 6 is a cross-sectional view of a liquid ejection substrate representing Modification 2 of FIG. 4A.

In Modification 2 of the first embodiment, the configuration may be such that the damper substrate 304 is provided with further common channels 206 as illustrated in FIG. 6 so as to reduce the flow resistance on the liquid. In this case, the depth (length in the Z direction) of the damper chambers 301 is preferably smaller than the depth of the common channels 206 from the perspective of the strength of the damper substrate 304.

The nozzle substrate 201, the actuator substrate 202, the channel substrate 203, and the damper substrate 304 can each be formed of a silicon substrate or the like. The damper film 300 is made of an elastic material. For example, resin materials such as polyimides and polyamides are usable. Note that the configurations, materials, and number of substrates forming the liquid ejection substrate 2 are not limited to those in this example.

As described in the present embodiment, the damper structures 302 and the atmospheric communication ports 303 are provided in the surface on the opposite side from the ejection surface 5. This enables the liquid ejection head to maintain desired damper performance even in a case where its ambient environment changes.

### Second Embodiment

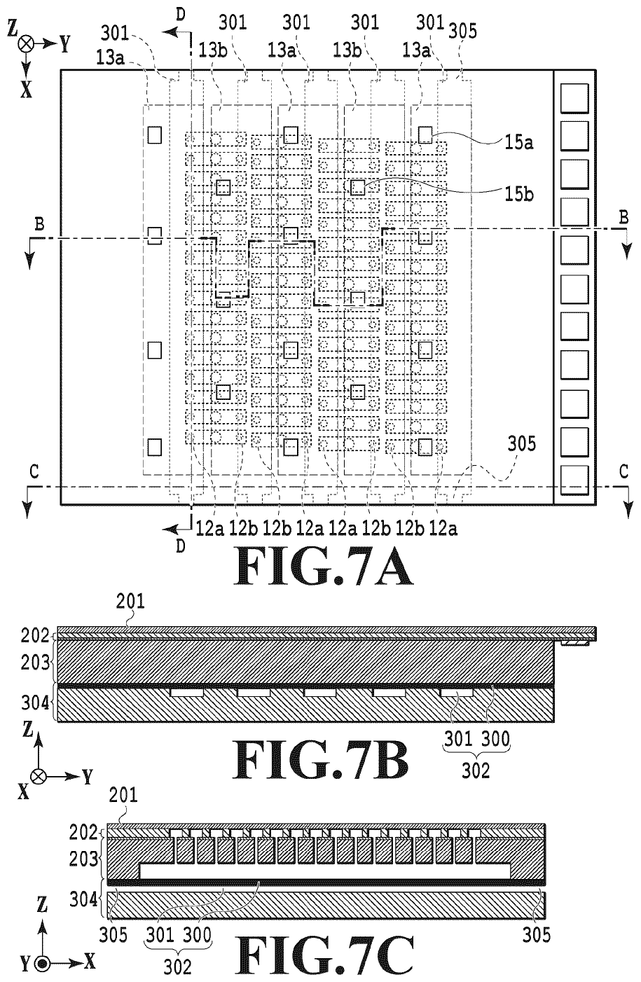

A second embodiment of the present disclosure will now be described. Descriptions of the basic configurations in the present disclosure and functions and components similar to those in the first embodiment will be omitted, and a difference will be described. In the present embodiment, another example of the atmospheric communication ports 303 will be described using FIGS. 7A to 7C.

FIG. 7A is an enlarged transparent plan view of a part of a liquid ejection substrate 2. FIG. 7B is a cross-sectional view taken along the C-C line in FIG. 7A. FIG. 7C is a cross-sectional view taken along the D-D line in FIG. 7A.

The second embodiment differs from the first embodiment in that atmospheric communication ports 305 are formed in a damper substrate 304. Specifically, as illustrated in FIGS. 7A to 7C, the atmospheric communication ports 305 are formed in the damper substrate 304. The atmospheric communication ports 305 are formed at the opposite ends of each damper chamber 301 so as to open in a direction parallel to an ejection surface 5, and are formed to have the same depth (length in the Z direction) as the depth of the damper chamber. Forming the atmospheric communication ports 305 at the opposite ends of the damper chambers 301 to the same depth as the damper chambers 301 facilitates the processing of the damper substrate 304. Also, the positions at which to form the common openings 15 may be set closer to the opposite ends of individual channels 12 than in the first embodiment, and the number of common openings 15 may be larger. Further, regions other than the common openings 15 can be used as adhesion regions for placing members for supplying and collecting the liquid to and from the common openings 15, which improves the adhesion strength and is therefore preferable.

The width of the atmospheric communication ports 305 in the Y direction is preferably smaller than the width of the damper chambers 301 in the Y direction. This can prevent entry of foreign substances such as dust into the damper chambers 301.

As described above, the damper structures 302 are provided in the surface on the opposite side from the ejection surface 5, and the atmospheric communication ports 305 are provided so as to open in a direction parallel to the ejection surface 5. This enables the liquid ejection head to maintain desired damper performance even in a case where its ambient environment changes, and also to improve the strength of adhesion to the members for supplying and collecting the liquid to and from the common openings 15.

### Third Embodiment

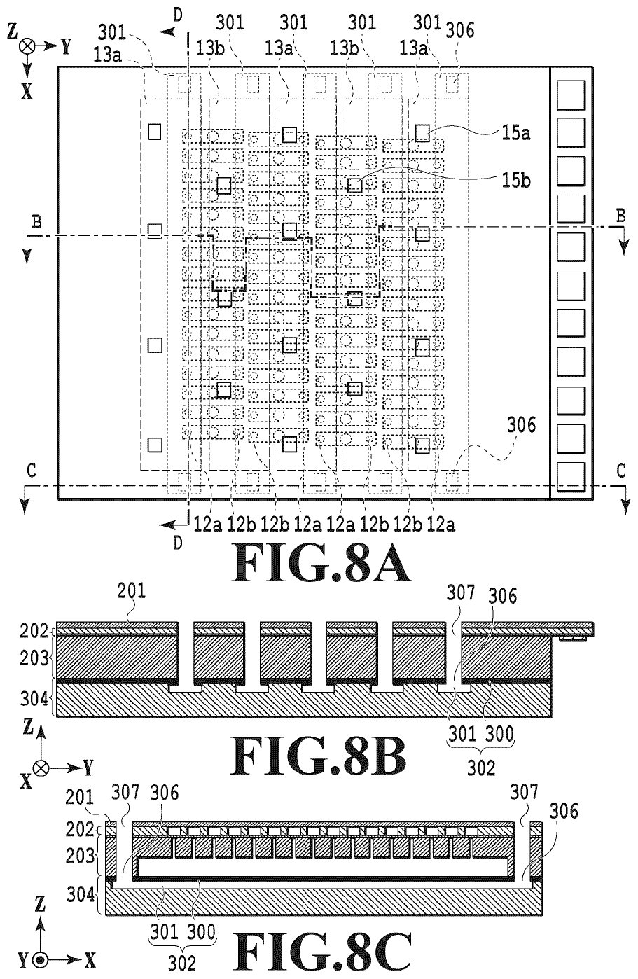

Next, a third embodiment of the present disclosure will be described. Descriptions of the basic configurations in the present disclosure and functions and components similar to those in the first embodiment will be omitted, and a difference will be described. In the third embodiment, an example of atmospheric communication ports different from the atmospheric communication ports 303 in the second embodiment will be described using FIGS. 8A to 8C.

FIG. 8A is an enlarged transparent plan view of a part of a liquid ejection substrate 2. FIG. 8B is a cross-sectional view taken along the C-C line in FIG. 8A. FIG. 8C is a cross-sectional view taken along the D-D line in FIG. 8A.

The third embodiment differs from the first and second embodiments in that atmospheric communication ports 306 are formed in a damper substrate 304, and atmospheric communication openings 307 are formed in a nozzle substrate 201, an actuator substrate 202, and a channel substrate 203. Specifically, as illustrated in FIGS. 8A to 8C, the atmospheric communication ports 306 are formed in the damper film 300 of the damper substrate 304, and the atmospheric communication openings 307 are formed through the channel substrate 203, the actuator substrate 202, and the nozzle substrate 201 and open at the ejection surface, thereby communicating with the atmosphere. A configuration as illustrated in FIGS. 8A to 8C provides advantageous effects similar to those of the second embodiment. It is preferable to form the atmospheric communication openings 307 to make it possible to set the positions at which to form the common openings 15 closer to the opposite ends of individual channels 12 than in the first embodiment, and to increase the number of common openings 15. Further, regions other than the common openings 15 can be used as adhesion regions for placing members for supplying and collecting the liquid to and from the common openings 15, which improves the adhesion strength and is therefore preferable.

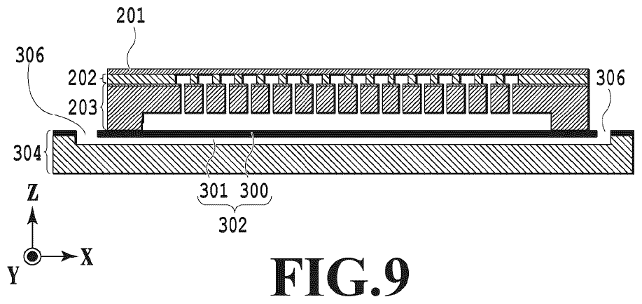

FIG. 9 is a cross-sectional view taken along the D-D line in FIG. 8A illustrating Modification 1.

In Modification 1 of the third embodiment, as illustrated in FIG. 9, the damper substrate 304 has the atmospheric communication ports 306 formed therein and is formed to be larger than the nozzle substrate 201, the actuator substrate 202, and the channel substrate 203. As the atmospheric communication ports 306, holes are formed at the opposite ends of the damper film 300 in the X direction so as to communicate with the atmosphere. This enables the liquid ejection head to maintain desired damper performance even in a case where its ambient environment changes.

Also, in a case of removing droplets attached to the ejection surface 5 with a wiper, using this modification will prevent the wiper from touching the atmospheric communication ports 306, which provides an advantageous effect of keeping the droplets from entering the atmospheric communication ports 306.

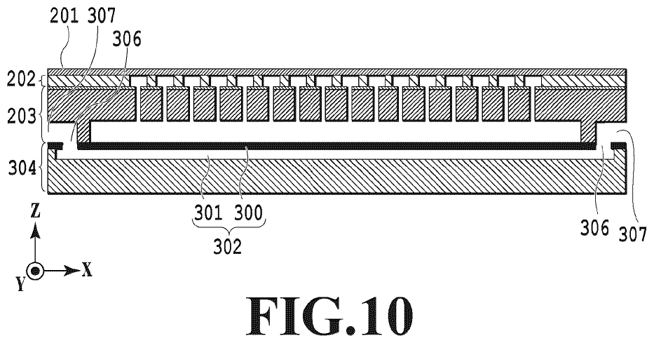

FIG. 10 is a cross-sectional view taken along the D-D line in FIG. 8A illustrating Modification 2.

In Modification 2 as a further modification of the third embodiment, as illustrated in FIG. 10, the damper substrate 304 has the atmospheric communication ports 306 formed therein, and also the atmospheric communication openings 307 are formed at the opposite ends of the channel substrate 203 at the same position as the common channels 13 in the Z direction so as to communicate with the atmospheric communication ports 306. This enables the liquid ejection head to maintain desired damper performance even in a case where its ambient environment changes.

The atmospheric communication openings 307 are formed at the same position in the Z direction as the common channels 13 to the same depth in the Z direction. Thus, the atmospheric communication openings 307 can be made in a single collective operation of processing the channel substrate 203. The width of the atmospheric communication openings 307 in the Y direction in FIG. 10 may be made smaller than the width of the damper chambers 301 as in FIG. 7A to make it difficult for foreign substances such as dust to enter the atmospheric communication openings 307 from the outside.

As described above, the damper structures are provided in the surface on the opposite side from the ejection surface, and the atmospheric communication ports are provided in the same direction as the ejection surface. This enables the liquid ejection head to maintain desired damper performance even in a case where its ambient environment changes, and also to improve the strength of adhesion to the members for supplying and collecting the liquid to and from the common openings 15.

### Fourth Embodiment

A fourth embodiment of the present disclosure will now be described. Descriptions of the basic configurations in the present disclosure and the same functions and components as those in the first embodiment will be omitted, and differences will be described.

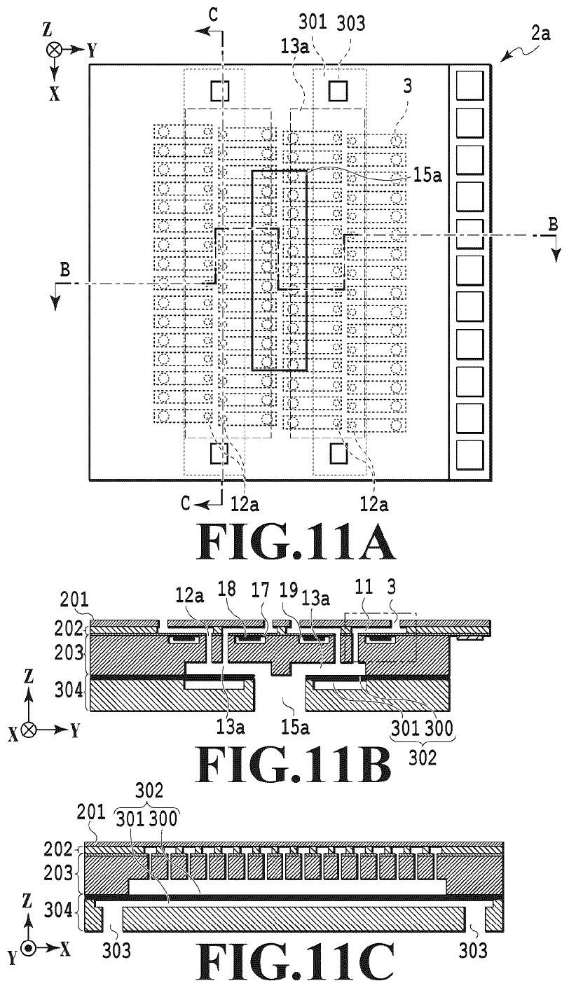

FIG. 11A is a partially enlarged transparent plan view of a liquid ejection substrate 2a in the liquid ejection head according to the present disclosure. FIG. 11B is a cross-sectional view taken along the B-B line in FIG. 11A. FIG. 11C is a cross-sectional view taken along the C-C line in FIG. 11A. As illustrated in FIG. 11A, a common supply opening 15a for supplying the liquid is formed substantially at the center of the liquid ejection substrate 2a. As the liquid is supplied to the common supply opening 15a, the liquid then passes through common supply channels 13a into individual supply channels 12a for the elements. After passing therethrough, the liquid is supplied to pressure chambers 11 and nozzles 3. Unlike the first embodiment, the configuration is such that the liquid is not circulated. In this configuration too, the nozzle chambers 11 are close to one another within each nozzle array and between the nozzle arrays, as in the first embodiment. Also, the configuration is such that adjacent nozzle arrays share a supply channel 13a. This leads to a concern about crosstalk in which a pressure wave in a pressure chamber 11 propagates to other pressure chambers 11 in its nozzle array and/or in the adjacent nozzle arrays, hence affecting the ejection characteristics. As illustrated in FIGS. 11A to 11C, atmospheric communication ports 303 are provided. This enables the liquid ejection head to maintain desired damper performance even in a case where its ambient environment changes.

### Fifth Embodiment

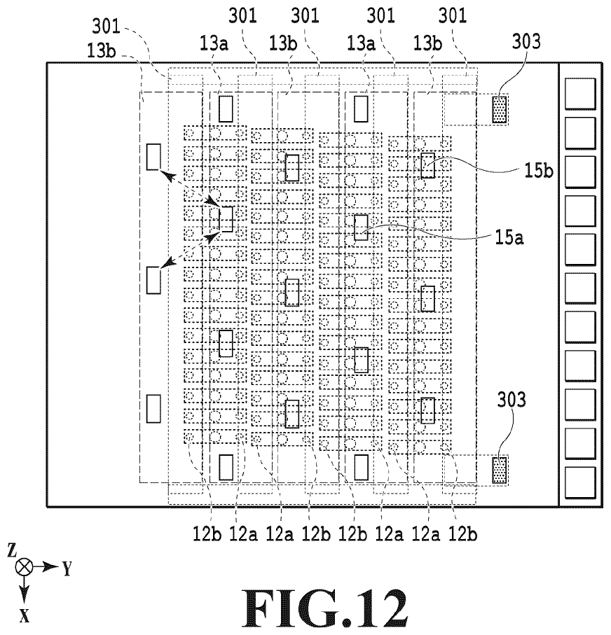

A liquid ejection substrate according to a fifth embodiment of the present disclosure will now be described. Note that descriptions of the basic configurations in the present disclosure and functions and components similar to those in the first embodiment will be omitted, and differences will be described. In the present embodiment, the liquid ejection substrate will be described using FIG. 12.

FIG. 12 is a plan view illustrating part of a liquid ejection substrate 2 according to the fifth embodiment. In the configuration of FIG. 12, a larger number of common supply openings 15a are provided per common supply channel 13a, and a larger number of common collection openings 15b are provided per common collection channel 13b. This allows efficient ink supply and collection to and from the liquid ejection substrate 2. The atmospheric communication ports 303 on either side in the nozzle array direction are integrated into a single atmospheric communication port at an end position in the nozzle array direction. Also, damper chambers 301 are connected by communication spaces provided closer to the chip's ends than are the common supply openings 15a and the common collection openings 15b, and are all at the same atmospheric pressure through the atmospheric communication ports 303. In this configuration, although the numbers of common supply openings 15a and common collection openings 15b are increased, certain distances are still maintained between the common supply openings 15a and the common collection openings 15b. This ensures a sufficient adhesion surface area for adhesively attaching a substrate for supplying the ink, so that sufficient adhesion strength will be achieved. Thus, ink leakage between the common supply openings 15a and the common collection openings 15b will be prevented from occurring.

The damper chambers 301 communicate with the atmosphere outside the head through the atmospheric communication ports, and will therefore not be affected by the use environment of this liquid ejection module. Also, since the damper chambers 301 communicate with the atmosphere, the compliance characteristic of the damper film 300 will not deteriorate, which reduces the impact on the effect of reduce pressure fluctuation. Thus, by bringing the inside of the damper chambers 301 into communication with the atmosphere outside the head, a pressure fluctuation occurring in one pressure chamber 11 will be prevented from affecting other pressure chambers 11. This reduces crosstalk between the pressure chambers 11 communicating with one another through the common channels 13, and thus reduces or prevents unintended changes in characteristics of droplets ejected from the nozzles 3. This in turn reduces or prevents a deterioration in the quality of printing on a print medium 111 by the liquid ejection apparatus 101 having the liquid ejection head module 1.

### Sixth Embodiment

A sixth embodiment of the present disclosure will now be described. Descriptions of the basic configurations in the present disclosure and functions and components similar to those in the first embodiment will be omitted, and differences will be described.

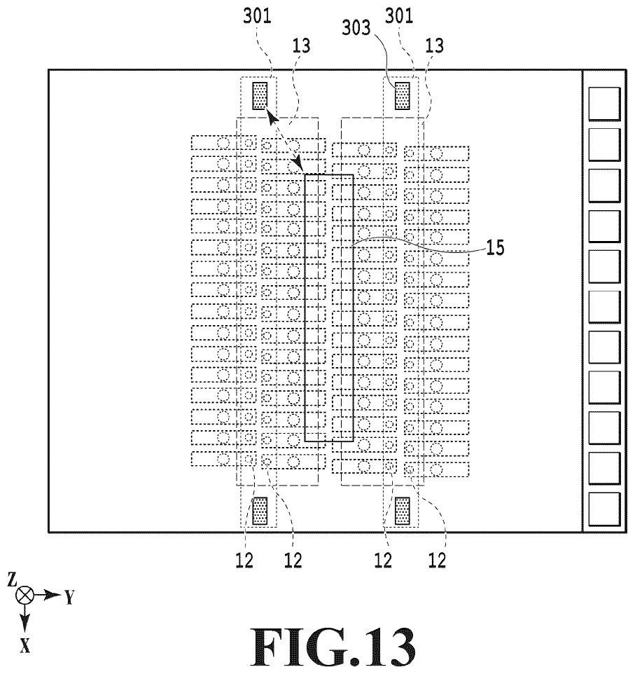

FIG. 13 is a plan view illustrating part of a liquid ejection substrate 2 according to the sixth embodiment. In the configuration according to the sixth embodiment, a single individual channel 12 is provided for each pressure chamber 11, and common channels 13 are provided so as to connect multiple individual channels 12. The common channels 13 are such that a single common channel 13 is connected to the individual channels 12 in two nozzle arrays, and damper chambers 301 are arranged at positions facing the individual channels 12. A common opening 15 having an opening elongated in the nozzle array direction (X direction) is provided for the two common channels 13. Atmospheric communication ports 303 are provided at the opposite ends of each damper chamber 301 and communicate with the atmosphere on the outside of the liquid ejection head.

In the present embodiment, each damper chamber 301 is provided so as to face the opposite ends of the individual channels 12 in two nozzle arrays, but a common channel 13 may be formed as to be connected to the individual channels 12 in three or more nozzle arrays.

In the configuration according to the present embodiment, a region to adhesively attach a substrate for supplying the ink is provided around the common opening 15. Hence, a sufficient adhesion surface area is secured for adhesively attach the substrate for supplying the ink. Accordingly, sufficient adhesion strength is achieved. Like the common opening 15, a sufficient adhesion surface area is secured around each atmospheric communication port 303 as well. In a case where similar structures are arranged side by side within the same liquid ejection substrate, a sufficient adhesion surface area is also secured between the common openings 15, so that sufficient adhesion strength is achieved. In a case where multiple common openings 15 are provided between the atmospheric communication ports 303, ink leakage between the common openings 15 will be prevented as well.

Since the damper chambers 301 communicate with the atmosphere through the atmospheric communication ports 303, the damper chambers 301 will not be affected by the use environment of the liquid ejection module and the compliance characteristic of the damper film 300 will therefore not deteriorate, which reduces the impact on the effect of reducing pressure fluctuation. Thus, by bringing the damper chambers 301 into communication with the atmosphere, a pressure fluctuation occurring in one pressure chamber 11 will be prevented from affecting other pressure chambers 11. This reduces crosstalk between the pressure chambers 11 communicating with one another through the common channels 13, and thus reduces or prevents unintended changes in characteristics of droplets ejected from the nozzles 3. This in turn reduces or prevents a deterioration in the quality of printing on a print medium 111 by the liquid ejection apparatus 101 having the liquid ejection head module 1.

### Seventh Embodiment

A configuration of a liquid ejection substrate 2 according to a seventh embodiment of the present disclosure will now be described. Descriptions of the basic configurations in the present disclosure and functions and components similar to those in the first embodiment will be omitted, and differences will be described.

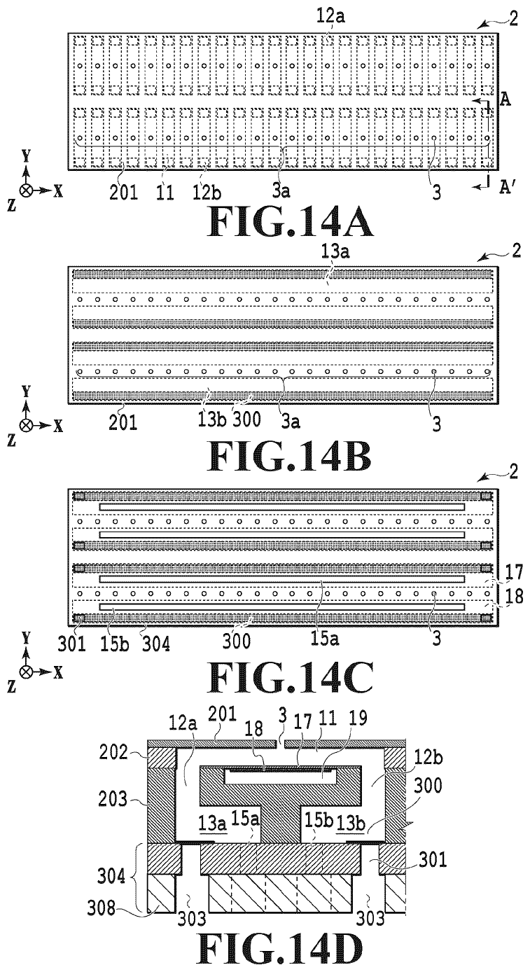

FIGS. 14A to 14D are schematic views of the liquid ejection substrate 2 according to the present embodiment. FIG. 14A and 14B are schematic plan views of the liquid ejection substrate 2 as seen from the ejection surface. FIG. 14C is a plan view of the liquid ejection substrate 2 as seen from the surface on the opposite side from the ejection surface. FIG. 14D is a cross-sectional view taken along the A-A′ line in FIG. 14A.

As illustrated in FIG. 14D, the liquid ejection substrate 2 according to the present embodiment includes a nozzle substrate 201, an actuator substrate 202, and a channel substrate 203 bonded on top of one another, and multiple nozzles 3 are disposed in the nozzle substrate 201. Also, the multiple nozzles 3 are arrayed to form nozzle arrays.

The actuator substrate 202 is desirably made of the material of a semiconductor substrate on which energy generation elements, electric circuits, electric wirings, and electronic devices such as temperature sensors to be disposed by semiconductor processing and in which channels can be formed by micro-electromechanical systems (MEMS) processing. Also, for the nozzle substrate 201 and the channel substrate 203, any materials can be used such as a resin substrate in which nozzles can be formed by laser processing and an inorganic plate in which nozzles can be formed by dicing. Further, for the nozzle substrate 201 and the channel substrate 203, any materials can be used such as a photosensitive resin material in which nozzles and channels can be formed by photocuring and a semiconductor substrate in which nozzle and channels can be formed by MEMS processing.

In the present embodiment, an ink of a single color is used as the liquid to be ejected from all nozzles, but a different color may be used for each nozzle array. Also, the liquid to be ejected may be a liquid other than ink.

At each of positions corresponding to the respective nozzles 3, there are a pressure chamber 11 formed by the actuator substrate 202 and a diaphragm 17 formed by the actuator substrate 202 as a deformable wall of the pressure chamber 11, and a piezoelectric element 18 is provided integrally with the diaphragm 17. The pressure generation element 18 deforms the diaphragm 17 based on a pulse signal input through an electric wiring (not illustrated) provided in the actuator substrate 202 to thereby pressurize the liquid inside the pressure chamber 11 and eject the liquid from the nozzle 3 with that pressure. Note that the actuator substrate 202 and the diaphragms 17 are not limited to separate members. For example, the actuator substrate 202 and the diaphragms 17 can be formed integrally with each other as a single member by using a silicon-on-insulator (SOI) substrate. Specifically, an SOI substrate obtained by forming a silicon oxide film, a silicon layer, and a silicon oxide film in this order on a silicon substrate can used to form the actuator substrate 202 with the silicon substrate and the diaphragms 17 with the silicon oxide film, the silicon layer, and the silicon oxide film thereon. Thus, the diaphragms 17 include those made of materials formed in films on a surface of the actuator substrate 202. Also, in the present embodiment, a method using deformation of piezoelectric elements has been described as the liquid ejection method, but a method which, for example, involves heating the liquid with a heater or the like and ejecting the liquid using the resulting bubbling phenomenon may be employed.

As illustrated in FIGS. 14B and 14C, in the channel substrate 203, a common supply channel 13a and a common collection channel 13b extend along each nozzle array 3a at positions on both sides of the nozzles 3. Moreover, in the channel substrate 203, the common supply channels 13a and the common collection channels 13b communicate with the pressure chambers 11 through individual supply channels 12a and individual collection channels 12b, respectively. Thus, circulatory flows are formed such that the liquid flows from the common supply channels 13a into the pressure chambers 11 through the individual supply channels 12a and then returns to the common collection channels 13b through the individual collection channels 12b on the other side. In the present embodiment, two common channels 13 are provided for one pressure chamber 11, but the two common channels 13 may communicate with each other as a single channel.

A damper chamber forming substrate 304 is laminated on the channel substrate 203. In the damper chamber forming substrate 304, damper chambers 301 are formed which are groove portions formed in the damper chamber forming substrate 304 at positions facing the individual supply channels 12a and the individual collection channels 12b and sealed with a damper film 300.

Note that, a thin metal film or a thin inorganic film that is resistant to organic solvents is preferably used as the material of the damper film 300, and its thickness is preferably 10 um or less. Also, atmospheric communication ports 303 are formed on the opposite side of the damper chambers 301 from the damper film 300. Moreover, in the surface of the damper chamber forming substrate 304 that is in contact with the channel substrate 203, common supply openings 15a and common collection openings 15b are formed which communicate with the common supply channels 13a and the common collection channels 13b, respectively. These common supply openings 15a and common collection openings 15b communicate with a support plate 308 on the surface on the opposite side from the channel substrate 203, and supply the ink supplied from the support plate 308 to the pressure chambers 11 and collect the ink from the pressure chambers 11 into the support plate 308.

As described above, in the present embodiment, the damper chambers 301 are provided with the atmospheric communication ports 303 to make the inside of the damper chambers 301 equivalent to the atmospheric environment. This will reduce or prevent the change in the compliance characteristic of the damper film 300 due to a difference from the ambient temperature and/or the atmospheric pressure. Accordingly, desired damper performance will be obtained. Also, the damper film 300 is disposed at surfaces facing the individual supply channels 12a and the individual collection channels 12b, and the damper chambers 301 are disposed on the opposite side of the damper film 300 from the channel substrate 203. Further, the atmospheric communication ports 303 are disposed on the opposite side of the damper chambers 301 from the channel substrate 203. Stacking the members and elements on top of one another in the ejection direction of the nozzles 3 minimizes the surface area in the direction of the ejection surface. This enables a dense nozzle layout and downsizing of the liquid ejection head 1.

### Eighth Embodiment

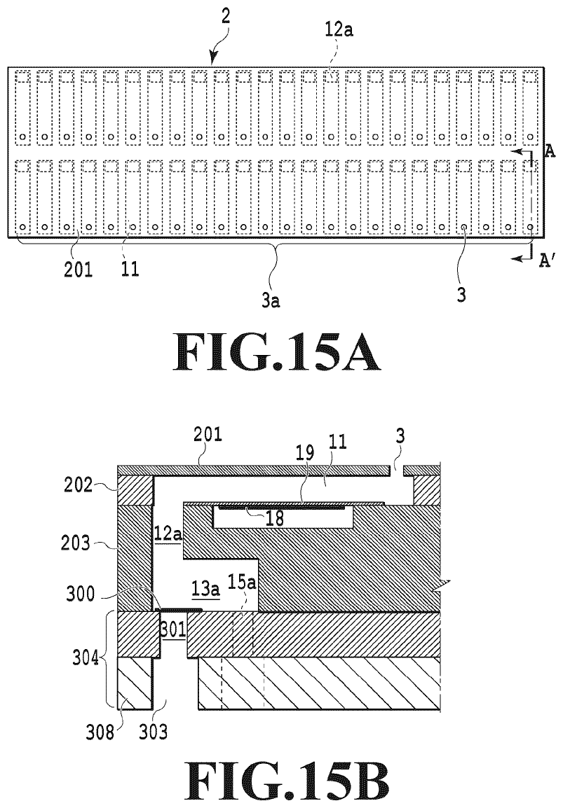

An eighth embodiment of the present disclosure will now be described. Descriptions of the basic configurations in the present disclosure and functions and components similar to those in the seventh embodiment will be omitted, and a difference will be described. FIG. 15A is a plan view of a liquid ejection substrate 2 according to the present embodiment. FIG. 15B is a cross-sectional view taken along the A-A′ line in FIG. 15A.

In the seventh embodiment, an individual supply channel 12a and an individual collection channel 12b are provided for each pressure chamber 11 and form a circulatory flow of an ink that passes through the pressure chamber 11. In contrast, in the present embodiment, only individual supply channels 12a are disposed, and the ink is not circulated and is just ejected from nozzles 3. In this embodiment too, members and elements are stacked on top of one another in the ejection direction of the nozzles 3 to minimize the surface area in the direction of the ejection surface. This enables a dense nozzle layout and downsizing of the liquid ejection head 1.

### Ninth Embodiment

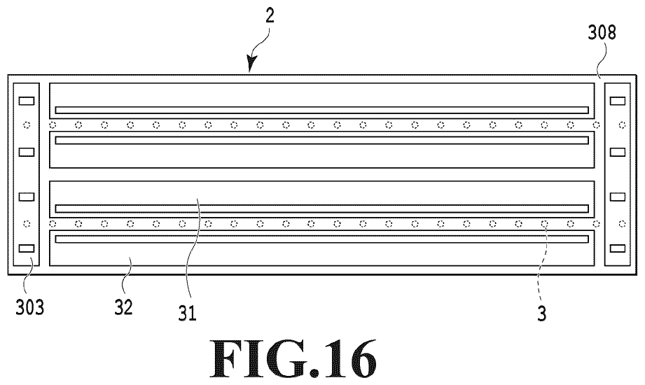

A ninth embodiment of the present disclosure will now be described. Descriptions of the basic configurations in the present disclosure and functions and components similar to those in the seventh embodiment will be omitted, and a difference will be described. FIG. 16 is a plan view of a liquid ejection substrate of a liquid ejection head according to a ninth embodiment.

As illustrated in FIG. 14D, a support plate 308 is adhesively attached to a damper substrate 304. In the support plate 308, multiple liquid supply ports 31, liquid collection ports 32, and atmospheric communication ports 303 are provided in correspondence with opening positions in the damper substrate 304. Moreover, as illustrated in FIG. 16, a liquid is supplied to the liquid ejection substrate 2 through the liquid supply ports 31 and is collected from the liquid ejection substrate 2 through the liquid collection ports 32, and the atmospheric communication ports 303 form paths communicating with the outside from damper chambers 301. For this support plate 308, any materials can be used such as a resin substrate in which nozzles can be formed by laser processing and an inorganic plate in which nozzles can be formed by dicing. Also, for the support plate 308, any materials can be used such as a photosensitive resin material in which nozzles and channels can be formed by photocuring and a semiconductor substrate in which nozzle and channels can be formed by MEMS processing. In the present embodiment, the support plate 308 and the liquid ejection substrate 2 are adhesively attached to each other. Here, in order to prevent ink leakage, a sufficient adhesion region is needed between the support plate 308 and the damper substrate 304. On the other hand, it is desirable to minimize the size of the liquid ejection substrate in order to achieve higher image quality. Furthermore, common supply channels 13a, common collection channels 13b, and the damper chambers 301 extend along the nozzle arrays. Here, the pressures and temperatures of the liquid and the atmosphere inside them are made uniform as much as possible. For this reason, the liquid supply ports 31, the liquid collection ports 32, and the atmospheric communication ports 303 are desirably disposed to be line symmetric about the center of the liquid ejection substrate 2. In the present embodiment, to satisfy these demands, the atmospheric communication ports 303 are disposed on outer sides such that the liquid supply ports and the liquid collection ports are situated therebetween. The liquid supply ports and the liquid collection ports need a large adhesion surface area to prevent liquid leakage. On the other hand, for the atmospheric communication ports 303, even if leakage occurs, it will be leakage of air. Thus, the atmospheric communication ports 303 does not need as large an adhesion surface area as that for the liquid. If the liquid supply ports and the liquid supply ports are disposed with the atmospheric communication ports 303 situated therebetween, large adhesion surface areas will be necessary between the liquid supply ports and the liquid supply ports and also between the liquid supply ports and liquid collection ports and the outer sides. In contrast, in the case where the atmospheric communication ports 303 are disposed with the liquid supply ports and the liquid collection ports situated therebetween, a large adhesion surface area is needed only between the liquid supply ports and liquid collection ports and the atmospheric communication ports 303. This reduces the total adhesion surface area and therefore enables downsizing of the liquid ejection substrate 2.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019938, filed Feb. 14, 2024, which is hereby incorporated by reference wherein in its entirety.

What is claimed is:

1. A liquid ejection head comprising a liquid ejection substrate having:
a nozzle substrate having a plurality of nozzles that eject a liquid;
a channel substrate having
a plurality of pressure chambers respectively communicating with the plurality of nozzles,
a plurality of individual channels respectively communicating with the plurality of pressure chambers,
a plurality of pressure generation units that respectively generate a pressure in the plurality of pressure chambers, and
a common channel communicating with the plurality of individual channels; and
a damper substrate positioned such that the channel substrate is interposed between the nozzle substrate and the damper substrate, and having
a damper film disposed so as to face a surface of the damper substrate facing an opening plane of a channel communicating with the common channel, and
a damper chamber one side of which is covered by the damper film, wherein
the liquid ejection substrate includes an atmospheric communication port through which an inside of the damper chamber communicates with atmosphere.

2. The liquid ejection head according to claim 1, wherein the atmospheric communication port is formed in a direction parallel to an ejection surface of the nozzle substrate in which the plurality of nozzles are formed.

3. The liquid ejection head according to claim 1, wherein the atmospheric communication port is formed on a side opposite to an ejection surface of the nozzle substrate in which the plurality of nozzles are formed.

4. The liquid ejection head according to claim 1, wherein the atmospheric communication port is formed on a side close to or at an ejection surface of the nozzle substrate in which the plurality of nozzles are formed.

5. The liquid ejection head according to claim 1, wherein the atmospheric communication port is formed at opposite ends of the damper chamber in a direction of extension of the damper substrate as viewed from a direction perpendicular to a surface of the damper substrate.

6. The liquid ejection head according to claim 1, wherein the atmospheric communication port is formed to be closer to an outer periphery of the damper substrate than the plurality of individual channels are as viewed from a direction perpendicular to a surface of the damper substrate.

7. The liquid ejection head according to claim 1, wherein a width of the atmospheric communication port in a direction parallel to a surface of the damper substrate and crossing a direction of extension of the damper chamber is smaller than a width of the damper chamber in the direction.

8. The liquid ejection head according to claim 1, wherein a size of the atmospheric communication port in a direction perpendicular to a surface of the channel substrate is equal to a size of the common channel.

9. The liquid ejection head according to claim 1, wherein a size of the atmospheric communication port in a direction perpendicular to a surface of the channel substrate is larger than a size of the damper chamber in the direction.

10. The liquid ejection head according to claim 1, wherein the atmospheric communication port is formed in the damper chamber.

11. The liquid ejection head according to claim 2, wherein the atmospheric communication port is formed so as to open at the channel substrate in a direction parallel to the ejection surface.

12. The liquid ejection head according to claim 1, further comprising a support plate disposed on an opposite side of the damper substrate opposite from a side thereof adjoining the channel substrate, wherein
the support plate has the atmospheric communication port and a supply port communicating with the common channel, and
the atmospheric communication port is formed on an outer side of the support plate relative to the supply port as viewed from a direction perpendicular to a surface of the support plate.

13. The liquid ejection head according to claim 1, wherein a size of the damper chamber in a direction perpendicular to a surface of the channel substrate is smaller than a size of the common channel in the direction.

14. The liquid ejection head according to claim 1, wherein the channel substrate has an individual channel substrate in which the individual channels are formed, and a common channel substrate in which the common channel is formed.

15. The liquid ejection head according to claim 14, wherein the liquid ejection head has a structure in which the individual channel substrate, the common channel substrate, and the damper substrate are arranged in this order in a direction perpendicular to a surface of the liquid ejection substrate.
